(19) United States
(12) Patent Application Publication
(10) Pub. No.: US 2008/0315531 A1
(43) Pub. Date: Dec. 25, 2008

(54) Sealing Profile for Joints Between Covering Plates

(76) Inventor: Josef Hrovath, Riegersdorf (AT)

Correspondence Address: KOLISCH HARTWELL, P.C., 200 PACIFIC BUILDING, 520 SW YAMHILL STREET, PORTLAND, OR, 97204, US

(21) Appl. No.: 11/884,177

(22) PCT Filed: Feb. 10, 2006
(86) PCT No.: PCT/AT06/00051

§ 371 Date: Jun. 20, 2008

(30) Foreign Application Priority Data
Feb. 11, 2005 (AT) A 231/2005

(51) Int. Cl. F16J 15/02

(52) U.S. Cl. 277/628

(57) ABSTRACT

The invention relates to a sealing profile for the sealing of joints between laid covering panels (2), having a base body (1, 18) which is composed of elastomeric material, with the sealing profile having, in cross section, a widening (10, 10′) on both sides on its foot end which faces toward the underlying surface (5).

The invention is characterized in that the widenings (10) are composed of elastomeric material and in that, from the foot face (11) of the base body (1), a groove or notch (12) is formed upward into the interior of said base body (1).

The invention relates to the sealing of joints between already-laid covering panels, in particular to a sealing profile having a base body which is composed of elastomeric material, with the sealing profile having, in cross section, a widening on both sides on its so-called foot end which faces toward the underlying surface. A sealing profile of said type is known from DE 198 00 554 A, which is recognized further below.

Covering panels can be composed of ceramic material, wood, stone, glass, high-grade steel, aluminum, PVC, rubber or polyurethane, a combination of said materials or similar materials, or else a material composite. In the latter case, said panels can be composed in particular of a support panel and at least one decorative panel, with the connection between these taking place either by means of adhesive or in that the support panel is composed of foamed material, in particular foamed polyurethane, and in a mold is integrally foamed onto the at least one decorative panel, which is to be considered as a lost core and which is usually composed of at least one of the above-stated materials.

Coverings made from panels of said type for floors, walls and ceilings are in several cases laid not by means of the classic areal adhesive bonding method in a thick bed or a thin bed (tiling adhesive), but are connected to specific positioning and retaining elements which themselves have been suitably fastened to the underlying surface.

Regardless of the type of laying, coverings composed of all of said covering panels have joints between the borders of adjacent covering panels, which joints must be closed in order to prevent the infiltration of dirt and foreign bodies, and to keep the covering as a whole visually attractive.

When laying tiles or stones in a bed of mortar or by means of tile adhesives, the introduction of a specific joint compound has in general been proven; in some cases, said joint compound, which usually has mortar properties, is replaced with plastic, for example silicone, and this in particular in the wet region.

In the case of covering panels laid by means of mechanical fastening elements, the use of a mortar-based joint filler is only theoretically possible; in practice, sufficiently fixed anchoring of the mortar cannot be guaranteed on account of the movements of the individual panels relative to one another both in the case of loading and also as a result of thermal expansion. In addition, said fastening possibilities for covering panels were created specifically in order to move away from the handling of mortar-like substances and to avoid soiling of the covering panels when introducing a joint filler of said type. If the covering panels are composed even only partially of a material which does not contribute to the frictional contact with mortar (wood, glass etc.), the use of a material of said type is inherently prohibited.

On account of the not unproblematic introduction of silicone into the joints and the technical skillfulness required for this purpose, and the subsequent smoothing of the joint and cleaning of adjacent surfaces, said previously known possibility for the closure of joints does not correspond to the aims of laying coverings in a suitable time.

A seal having the features specified in the introduction, but for other coverings, is known from the already-cited DE 198 00 554 A. Here, two L-shaped profiles composed of hard PVC which are arranged mirror-symmetrically with a spacing are connected to one another along their upper edges by means of an elastic bridge which constitutes the sealing profile. The cavity formed in this way is protected against the infiltration of mortar, adhesive etc. in the base region of the profiles by means of a thin covering band, for example a double-sided adhesive band. In the finished state, the base covering rests with its border region on the limbs, which lie on the underlying surface, of the previously laid seal. Said seal cannot be used for retroactive assembly. Said seal can in fact be used only for cast coverings or panels laid in a bed of mortar.

Known for retroactive assembly is the use of a plastic or rubber strip as a seal which, after the laying of the individual covering panels, is pressed into the joints and remains adhered there by means of frictional engagement. In this regard, reference is made to DE 199 62 812 A. Said document discloses a seal which is referred to as a cover profile and which interacts with a border profile into which the individual covering panels are placed. Said preassembled border profile has, on the side facing the seal, a sawtooth form which points toward the underlying surface, and the sealing profile in turn has a sawtooth form in cross section which is complementary thereto, so that, with correct laying, said profiles hook into one another. The introduction of the seal can take place only because the sealing profile is of hollow design and can be pressed into the joint by means of elastic deformation.

Said sealing system has some notable disadvantages: the border profile is in each case of single-piece design for two adjacent covering panels, so that the actual sealing strip lies in a U-shaped trough which is closed off at the bottom, and serves more of a visual purpose than a sealing purpose. The actual joint is doubled and is situated in each case between a covering panel and the border profile and does not undergo any treatment, so that, by means of said measures, the problem of the joint sealing is only displaced.

U.S. Pat. No. 5,282,693 A relates to the sealing of joints in the case of freeway surfaces made from concrete, and is composed of a profile made from elastomeric material which is inserted in a fitting manner into the joint and is sealed tightly with the concrete there with a further material. The disadvantages are at least the same as with the use of the abovementioned silicone; this seal is not suitable for conventional coverings composed of panels.

U.S. Pat. No. 4,717,162 A describes an elastomeric sealing strip for expansion joints in a pavement, in the case of which a widening at both sides is arranged in the center of the height of the cross section of the seal, because the expansion joint extends further downward. The seal projects upward beyond the surface of the pavement and is encased by the actual covering which is composed of grouting compound. Retroactive introduction is ruled out entirely.

DE 103 01 162 A discloses a very complex, multipart component for bridging a movement joint, which component is anchored at both sides under the pavement by means of bolts in the concrete. The actual joint is formed by a strip made from elastomeric material, whose height position can be adjusted even after laying. Retroactive laying is also ruled out entirely here.

In contrast to said prior art, it is an aim and object of the invention to specify a joint seal which can dispense with additional profile strips or edge covers to be assigned to the covering panels, and which can be quickly and simply fastened after the laying of the covering panels.

According to the invention, in order to achieve said aims in a sealing profile of the type specified in the introduction, it is provided that the widenings are composed of elastomeric material and that, from the lower end face, which faces toward the underlying surface, of the profile, a groove or notch is formed upward into the interior of the profile in the central region.

A sealing strip of said type can interact with all covering panels, in particular those which, on their border region which faces toward the underlying surface, have a chamfer, a bevel, a “broken edge” or recess, that is to say—specifically for the avoidance of chipping—virtually all known covering panels, since when pressing the sealing profile in, an elastic compression of the widening foot is possible, as a result of which the relatively wide part of the foot can also be pressed through the joint and, after reaching the recess of the covering panel, expands again and therefore ensures a secure seat of the sealing profile.

The invention is explained in more detail below on the basis of the drawing, in which:

FIG. 1 shows a typical installation situation in a schematic section,

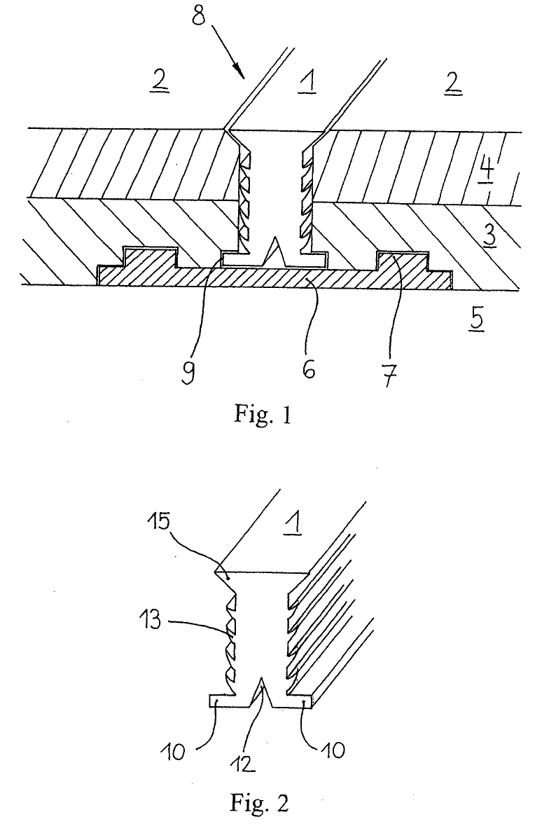

FIG. 2 shows a sealing profile designed according to the invention, schematically in a perspective view,

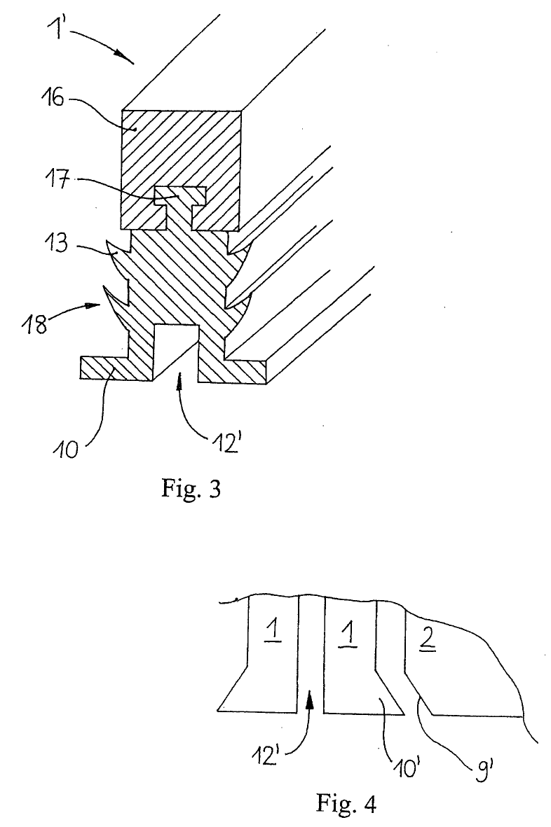

FIG. 3 shows a variant of a sealing profile according to the invention, and

FIG. 4 shows a detail of a further variant.

FIG. 1 illustrates a sealing profile 1 according to the invention between two covering panels 2 in a typical laying situation. The covering panels 2 are composed of a support panel 3 and a decorative panel 4. The assembly on the underlying surface 5 takes place by means of fastening panels 6 which interact, for example by means of elastically resilient clip-like or pushbutton-like connecting elements 7, with corresponding elements on the support panel 3.

It is self-evidently possible, as already mentioned in the introduction, for the covering panels to be of different design and/or to be fastened to the underlying surface in some other way. It is essential, and in virtually all known coverings composed of covering panels unavoidable, that a joint 8 is generated between adjacent covering panels 2, which joint 8 must be sealed off and filled.

Virtually all known covering panels have a peripheral recess 9 along their border on the edge which faces toward the underlying surface 5. As a result of said recess, which of course need not have the cross-sectional shape illustrated in FIG. 1, the joint 8 widens in its region facing toward the underlying surface 5, and thus forms a possibility for a fixed anchoring of a sealing profile 1 designed according to the invention.

As can be clearly seen in particular from FIG. 2, a sealing profile 1 designed according to the invention has a widening 10 at both sides in its foot region which, in the laid state, is to be understood to mean the lower region of the profile which faces toward the underlying surface 5. Since the usual rubber or silicone material used for seals (other materials such as polyurethanes etc. are possible and can be easily selected by a person skilled in the art with knowledge of the field of application) generally has excellent elasticity but only low compressibility, it would be only possible with difficulty, or in some circumstances even impossible, to press a sealing profile of said design into a considerably narrower joint, wherein the width of the foot region of the nondeformed sealing profile 1 is to be considered as a comparison.

However, an “elastomeric material” is to be understood generally as any material which, under the conditions of use during its normal service life, remains elastically deformable at least to such an extent as to be held in the joint and to seal the latter.

In order to now permit assembly without adversely affecting the fixed seating, according to the invention, a groove or notch 12 is formed proceeding from the base face 11 of the profile, which groove or notch 12 makes it possible to press the foot part of the sealing profile 1 into the joint 8 by means of elastic deformation and with negligible compression, or even without compression, of the material until the foot part passes into the region of the recess or undercut 9 of the covering panels and again at least largely assumes its undeformed shape. Complete correlation of the assembly cross section with the undeformed shape is not generally sought in order to ensure the fixed seating of the sealing profile 1 in the joint 8 by means of a remaining residual elastic deformation.

In a way known per se, the sealing profile 1 is provided laterally with strip-shaped projections 13 whose shape and dimensions are selected such that they bear sealingly against the end faces of the adjacent covering panels in the assembled state of the sealing profile 1. As illustrated, said sealing lips are preferably aligned away from the foot face, therefore upward in the laying situation, to an increasing degree in the outward direction, and thus facilitate the pressing in of the seal into the joint 8. Sealing lips or sealing panels of said type are known in various forms in other contexts from the prior art, and require no further explanation here.

One advantageous embodiment of the seal is realized in the exemplary embodiment illustrated; this involves the chamfering 14 of the upper edges of the covering panels 2 and a corresponding broadening 15 of the sealing profile 1. As a result of said complementary design of the cross sections, the best possible filling of the joint 8 is obtained, because most covering panels which are used have chamfering of their upper edges in order to avoid injuries and protrusions, which chamfering is partially problematic to fill during the filling of the joint.

In the variant according to the invention, it is possible to match the height of the sealing profile to the known height of the covering panels in such a way that the sealing profile is loaded under tension between its foot region and the broadening 15 in the installed state, and the broadening 15 therefore bears fixedly and sealingly against the beveling or chamfer 14.

Here, reference is made in comparison thereto to the sealing profile of the cited DE 199 62 812 A, where a Christmas-tree-like congruence between the sealing profile and the adjacent end face is provided over the entire contact area, as a result of which the generation of tensile forces, which improve the seal, in the uppermost region of the seal is severely adversely affected. It is also the case in the previously known design that the continuous core which is required for the introduction of the sealing profile is complex to produce and permanently weakens the lateral pressing force in precisely the region in which it is desired on account of the sealing action.

A variant of the invention is illustrated in FIG. 3: here, the sealing profile, which is denoted by 1′, has a strip 16 made from a different material, for example aluminum, plastic, etc., which is visually attractive in combination with the respective covering panels, which strip 16 is arranged on the upper side of a base body or of the actual sealing part 18. The covering panels (not illustrated) in this case preferably have no chamfers 14 (FIG. 1) at their upper edges but rather have recesses which correspond in shape and size to the shape and size of the strip 16. The shape and size of the cross section of the strip need not be that which is illustrated purely schematically; a trapezium shape is particularly favorable on account of the pulling action into the joint.

The connection between the actual sealing part 18 and the strip 16 takes place either by means of adhesive or by means of a T-shaped retaining strip 17 which is indicated purely schematically in FIG. 3 and which is preferably produced in one piece with the sealing part 18 itself. On account of the fact that it can be dispensed with, said retaining strip 17 has been illustrated as a separate part, and purely schematically without any consideration as to how it can be inserted into the strip 16.

As can be seen from FIG. 3, as a result of the provision of the strip 16, there is no loss in terms of the technical properties of the sealing profile 1 (which, here, in its entirety, forms the base body) or 1′ (having the base body 18 and the strip 16) with regard to the advantages which can be obtained; in contrast, a further visual design possibility is obtained. The groove 12′ is of rectangular design in this exemplary embodiment.

FIG. 4 shows, presented in section adjacent to one another, the foot end of a seal 1 as an enlarged detail with a widening 10′ which is a variant of the widening 10 of FIG. 1, and a covering panel 2 with a chamfer 9′ which is adapted thereto and is often present in the prior art.

The invention can be modified in various ways and is not restricted to the exemplary embodiment shown. For example, the shape and size of the individual regions of the base body, in particular of the lateral widenings 10 and the number and design of the projections 13, can be of different design to those illustrated. It is essential that the seal can be inserted after the laying of the panels, and that said seal is in direct contact with the side faces of said panels. Here, it is not important whether the panels rest on fastening panels 6 or are adhesively bonded to a base face or are laid in a bed of mortar.

1. A sealing profile for the sealing of joints between laid covering panels (2), having a base body (1, 18) which is composed of elastomeric material, with the sealing profile having, in cross section, a widening (10, 10′) on both sides on a foot end which faces toward the underlying surface (5), characterized in that the widenings (10, 10′) are composed of elastomeric material and in that, from a foot face (11) of the base body (1, 18), a groove or notch (12, 12′) is formed upward into an interior of said base body (1, 18).

2. The sealing profile according to claim 1, characterized in that the base body has laterally protruding strip-shaped projections (13) configured to bear sealingly against an end face of an adjacent covering panel (2).

3. The sealing profile according to one of claims 1 or 2, characterized in that a head region of the base body has a broadening (15).

4. The sealing profile according to one of claims 1 or 2, characterized in that a head region of the base body includes a strip (16) composed of a different material than the base body (18).

5. The sealing profile according to one of claims 1 or 2, characterized in that a height of the sealing profile in an undeformed state is less than a corresponding height of the sealing profile in an assembled state.

6. The sealing profile according to one of claims 1 or 2, characterized in that the widenings (10) are formed in one piece with the base body (18).

7. The sealing profile according to claim 2, characterized in that the laterally protruding strip-shaped projections (13) are formed in one piece with the base body (18).

8. The sealing profile according to claim 2, characterized in that the laterally protruding strip-shaped projections are aligned away from the foot face to an increasing degree in an outward direction.
